(19) United States
(12) Patent Application Publication
(10) Pub. No.: US 2024/0056898 A1
(43) Pub. Date: Feb. 15, 2024

(54) TRANSPORT BLOCK SIZE FOR SIDELINK COMMUNICATIONS

(71) Applicant: QUALCOMM Incorporated, San Diego, CA (US)

(72) Inventors: Chih-Hao LIU, San Diego, CA (US); Giovanni CHISCI, San Diego, CA (US); Jing SUN, San Diego, CA (US); Xiaoxia ZHANG, San Diego, CA (US); Yisheng XUE, San Diego, CA (US)

(21) Appl. No.: 17/885,293

(22) Filed: Aug. 10, 2022

(51) Int. Cl. H04W 28/26; H04W 72/04; H04W 72/02; H04L 1/08

(52) U.S. Cl. CPC H04W 28/26; H04W 72/0453; H04W 72/02; H04L 1/08

(57) ABSTRACT

Various aspects of the present disclosure generally relate to wireless communication. In some aspects, a user equipment (UE) may obtain a nominal resource block value associated with one or more allocated subchannels for a sidelink communication. The UE may identify a number of physical sidelink shared channel (PSSCH) resource elements to be used for a transport block size calculation based at least in part on the nominal resource block value. The UE may transmit the sidelink communication, and reserve one or more resources for one or more respective retransmissions of the sidelink communication, based at least in part on the number of PSSCH resource elements. Numerous other aspects are described.

### FIELD OF THE DISCLOSURE

Aspects of the present disclosure generally relate to wireless communication and to techniques and apparatuses for transport block size for sidelink communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include obtaining a nominal resource block value associated with one or more allocated subchannels for a sidelink communication. The method may include identifying a number of physical sidelink shared channel (PSSCH) resource elements to be used for a transport block size calculation based at least in part on the nominal resource block value. The method may include transmitting the sidelink communication, and reserving one or more resources for one or more respective retransmissions of the sidelink communication, based at least in part on the number of PSSCH resource elements.

Some aspects described herein relate to an apparatus for wireless communication performed by a UE. The apparatus may include a memory and one or more processors, coupled to the memory. The one or more processors may be configured to obtain a nominal resource block value associated with one or more allocated subchannels for a sidelink communication. The one or more processors may be configured to identify a number of PSSCH resource elements to be used for a transport block size calculation based at least in part on the nominal resource block value. The one or more processors may be configured to transmit the sidelink communication, and reserve one or more resources for one or more respective retransmissions of the sidelink communication, based at least in part on the number of PSSCH resource elements.

Some aspects described herein relate to a non-transitory computer-readable medium that stores a set of instructions for wireless communication by a UE. The set of instructions, when executed by one or more processors of the UE, may cause the UE to obtain a nominal resource block value associated with one or more allocated subchannels for a sidelink communication. The set of instructions, when executed by one or more processors of the UE, may cause the UE to identify a number of PSSCH resource elements to be used for a transport block size calculation based at least in part on the nominal resource block value. The set of instructions, when executed by one or more processors of the UE, may cause the UE to transmit the sidelink communication, and reserve one or more resources for one or more respective retransmissions of the sidelink communication, based at least in part on the number of PSSCH resource elements.

Some aspects described herein relate to an apparatus for wireless communication. The apparatus may include means for obtaining a nominal resource block value associated with one or more allocated subchannels for a sidelink communication. The apparatus may include means for identifying a number of PSSCH resource elements to be used for a transport block size calculation based at least in part on the nominal resource block value. The apparatus may include means for transmitting the sidelink communication, and reserving one or more resources for one or more respective retransmissions of the sidelink communication, based at least in part on the number of PSSCH resource elements.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of interlaced waveforms for physical sidelink control channel and physical sidelink shared channel communications, in accordance with the present disclosure.

FIG. 6 is a diagram illustrating an example of resource block scheduling in accordance with a sidelink frequency domain resource allocation, in accordance with the present disclosure.

FIG. 7 is a diagram illustrating an example of transport block size calculation for sidelink communications, in accordance with the present disclosure.

FIG. 8 is a diagram illustrating an example process performed, for example, by a UE, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

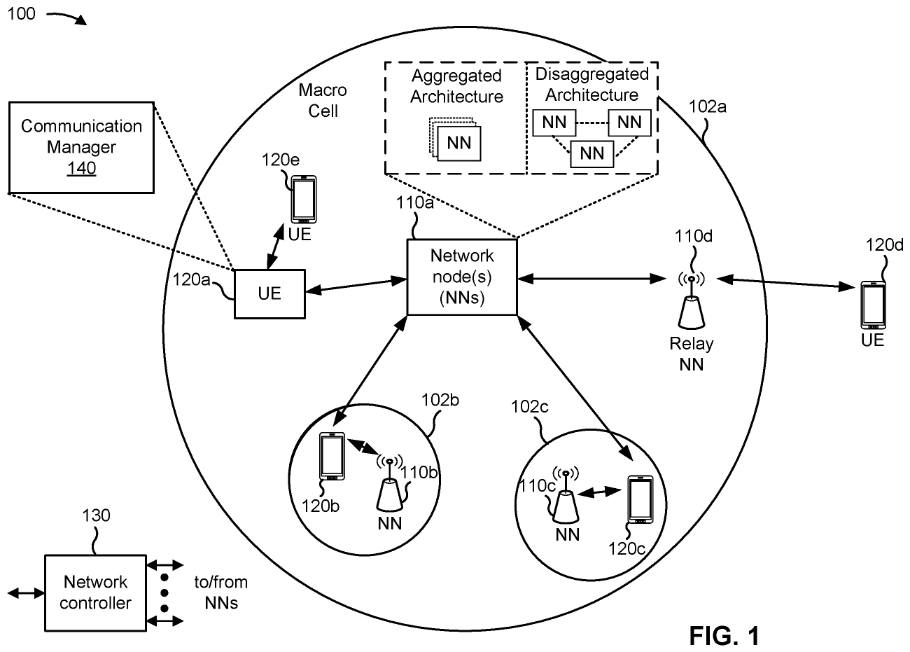

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may obtain a nominal resource block value associated with one or more allocated subchannels for a sidelink communication; identify a number of physical sidelink shared channel (PSSCH) resource elements to be used for a transport block size calculation based at least in part on the nominal resource block value; and transmit the sidelink communication, and reserve one or more resources for one or more respective retransmissions of the sidelink communication, based at least in part on the number of PSSCH resource elements. Additionally, or alternatively, the communication manager 140 may perform one or more other operations described herein.

As indicated above, FIG. 1 is provided as an example. Other examples may differ from what is described with regard to FIG. 1.

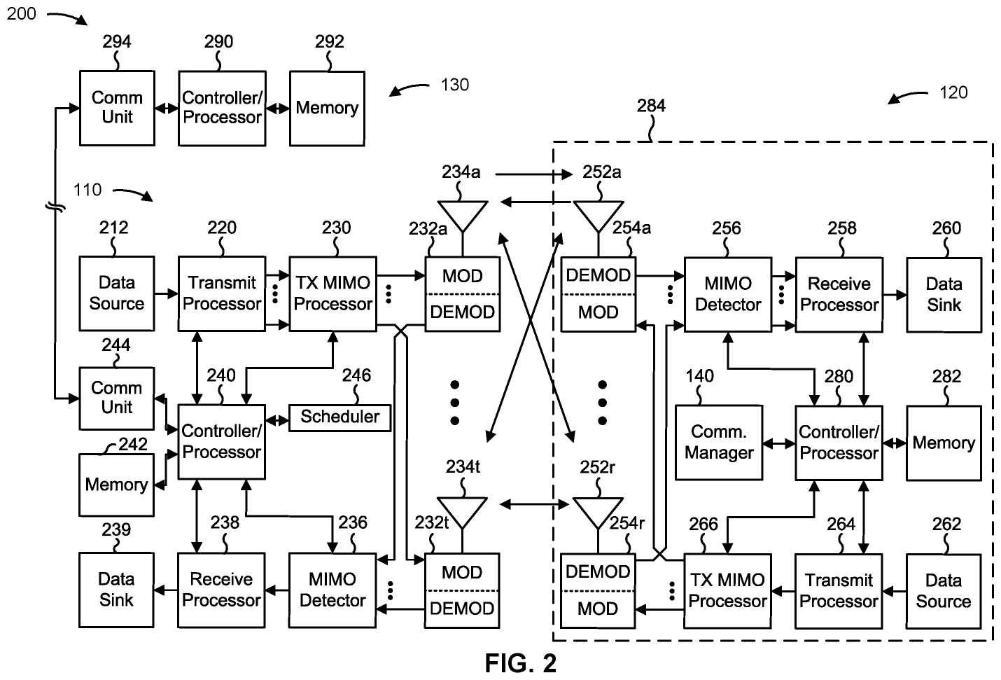

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

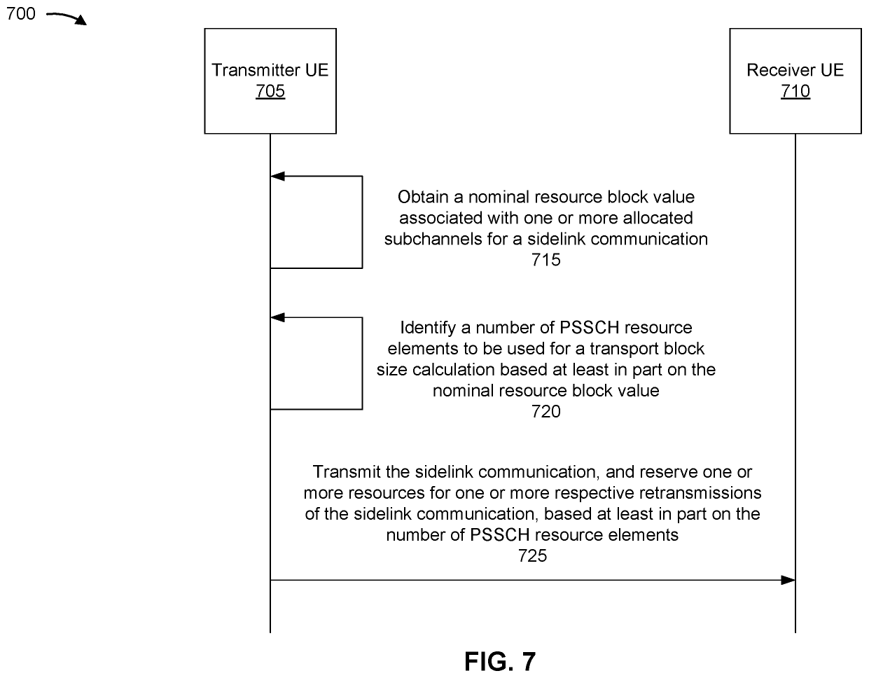

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-9).

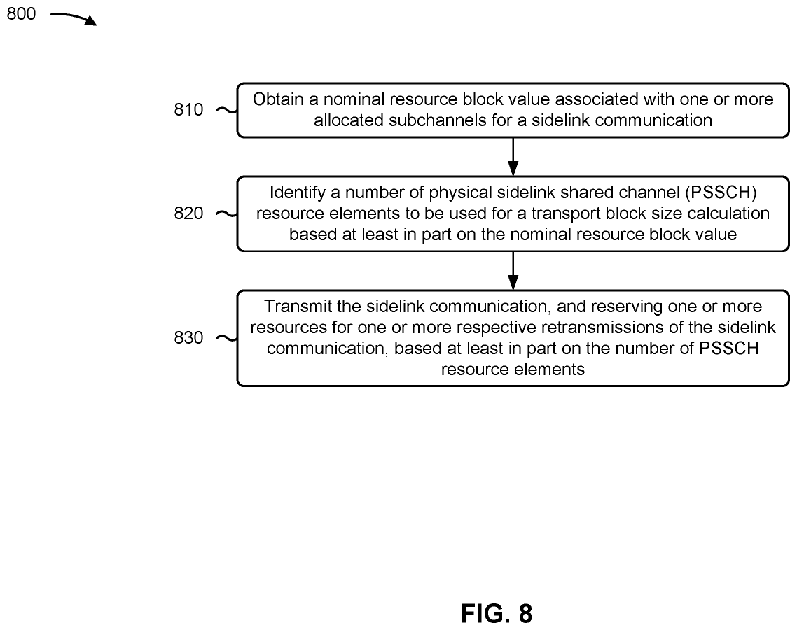

The controller/processor 240 of the network node 110, the controller/processor 280 of the UE 120, and/or any other component(s) of FIG. 2 may perform one or more techniques associated with transport block size for sidelink communications, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, and/or other processes as described herein. In some examples, executing instructions may include running the instructions, converting the instructions, compiling the instructions, and/or interpreting the instructions, among other examples.

In some aspects, a UE (such as the UE 120) includes means for obtaining a nominal resource block value associated with one or more allocated subchannels for a sidelink communication; means for identifying a number of PSSCH resource elements to be used for a transport block size calculation based at least in part on the nominal resource block value; and/or means for transmitting the sidelink communication, and reserving one or more resources for one or more respective retransmissions of the sidelink communication, based at least in part on the number of PSSCH resource elements. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

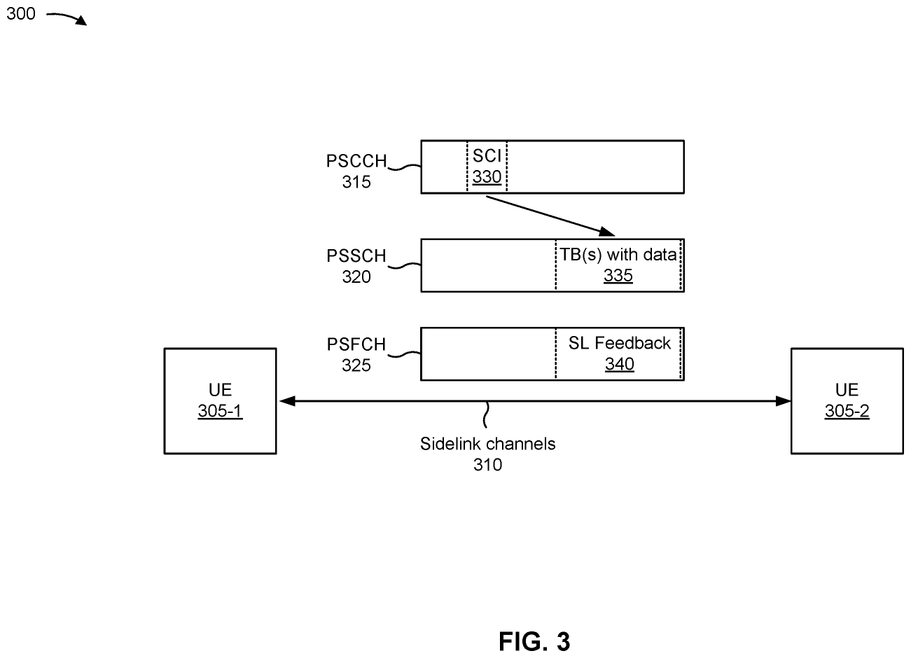

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

In some cases, a UE (such as the UE 305-1 or the UE 305-1) may identify a number of PSSCH resource elements to be used for a transport block size calculation based at least in part on a nominal resource block value. The UE may transmit a sidelink communication and may reserve one or more resources for one or more respective retransmissions of the sidelink communication based at least in part on the identified PSSCH resource elements. Additional details regarding these features are described below.

As indicated above, FIG. 3 is provided as an example. Other examples may differ from what is described with respect to FIG. 3.

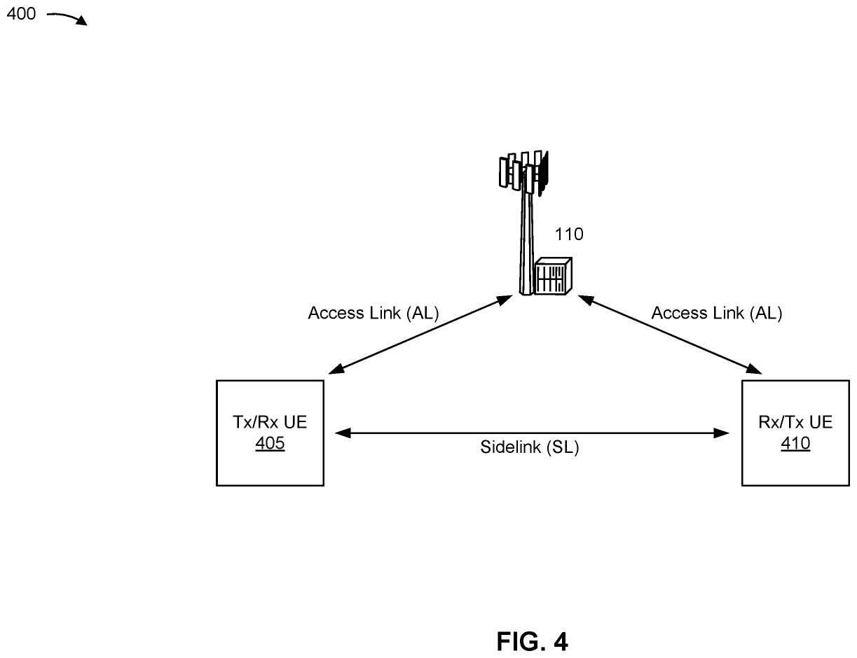

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

In some cases, a UE (such as the UE 405 or the UE 410) may identify a number of PSSCH resource elements to be used for a transport block size calculation based at least in part on a nominal resource block value. The UE may transmit a sidelink communication and may reserve one or more resources for one or more respective retransmissions of the sidelink communication based at least in part on the identified PSSCH resource elements. Additional details regarding these features are described below.

As indicated above, FIG. 4 is provided as an example. Other examples may differ from what is described with respect to FIG. 4.

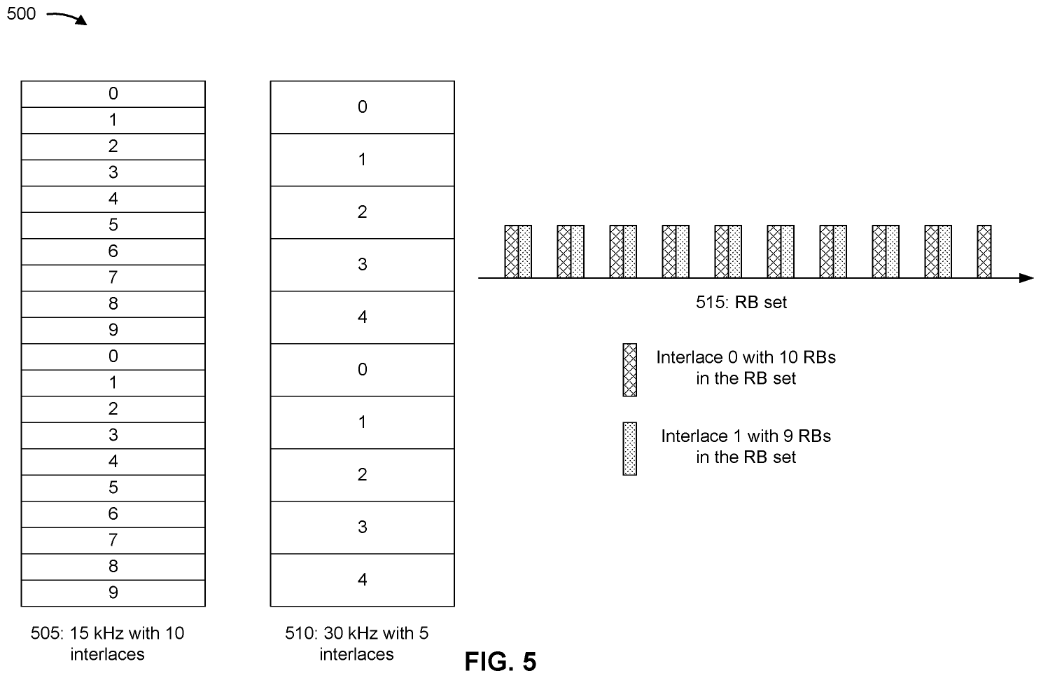

FIG. 5 is a diagram illustrating an example 500 of interlaced waveforms for PSCCH and PSSCH communications, in accordance with the present disclosure.

In some cases, as shown by reference number 505, a subchannel for PSCCH and PSSCH communications may be configured for 15 kHz subcarrier spacing (SCS) with ten interlaces (e.g., interlaces 0-9). In some cases, as shown by reference number 510, a subchannel for PSCCH and PSSCH communications may be configured for 30 kHz SCS with five interlaces (e.g., interlaces 0-4). A subchannel may be defined as k interlaces in a single subband (e.g., −20 MHz), which may also be referred to as a resource block set. In some cases, the number of resource blocks in the subchannel may not be fixed. For example, the number of resource blocks in the subchannel may be based at least in part on the guard band (e.g., intra-cell resource block set) setting. In some cases, as shown by reference number 515, different interlaces may be configured with a different number of resource blocks for a resource block set. For example, a first interlace (interlace 0) may be configured with ten resource blocks in the resource block set, and a second interlace (interlace 1) may be configured with nine resource blocks in the resource block set. In some cases, an initial transmission of a communication (e.g., a sidelink communication) may be performed using interlace 0 that includes ten resource blocks, while a retransmission of the communication may be scheduled for interlace 1 that includes only nine resource blocks. As described herein, this may result in at least a portion of the communication not being properly retransmitted.

In some cases, resources may be multiplexed, for example, using time division multiplexing (TDM) and/or frequency division multiplexing (FDM). For example, one or more resources may be multiplexed (using TDM or FDM) with a PSCCH, where the PSCCH is the leading interlace. In some cases, rate matching may be performed based at least in part on a minimum resource block set or a configured resource block set. In a first type of communication (e.g., a phase 1 communication), a transmitter and a receiver may communicate the resource block configuration via RRC signaling (e.g., via RRC configuration messages) using the PSSCH rate matching over the minimum resource block set. In a second type of communication (e.g., a phase 2 communication), the PSSCH may be rate matched to the configured resource block set (e.g., to improve efficiency). In some cases, second stage SCI (SCI-2) may be rate matched to the minimum resource block set(s) indicated by first stage SCI (SCI-1). The resource block set configuration for the phase 2 communication may be transmitter-centric (e.g., may be based at least in part on one or more transmitter characteristics). In this case, the receiver may determine an identifier associated with the transmitter for adjusting the resource block set configuration for reception. The identifier associated with the transmitter may be included in the SCI-2. In some cases, based on the phase 1 communication and/or the phase 2 communication, the PSSCH may be rate matched based at least in part on the minimum resource block sets and/or the configured resource block sets as indicated by the SCI-1. In some cases, the PSSCH resource mapping may be wideband over multiple contiguous resource block sets (including the guard bands). Additional details regarding these features are described below.

As indicated above, FIG. 5 is provided as an example. Other examples may differ from what is described with respect to FIG. 5.

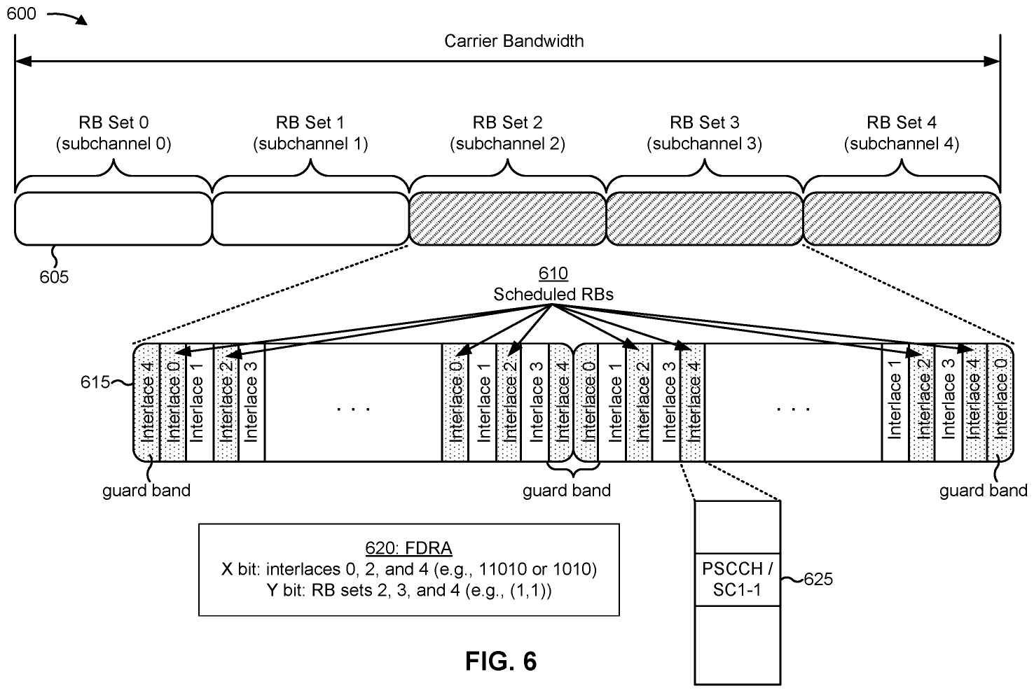

FIG. 6 is a diagram illustrating an example 600 of resource block scheduling in accordance with a sidelink frequency domain resource allocation, in accordance with the present disclosure.

As shown by reference number 605, a carrier bandwidth (sometimes referred to as a channel) is divided into a number of RB sets or subchannels. In the depicted example, the carrier bandwidth includes five RB sets (indexed as RB set 0, RB set 1, RB set 2, RB set 3, and RB set 4), but in other cases, the carrier bandwidth may include more or fewer RB sets. For example, in some cases, the carrier bandwidth may be 80 MHz, and may include four 20 MHz RB sets or subchannels. In some other cases, the carrier bandwidth may be 100 MHz, and may include five 20 MHz RB sets or subchannels.

As indicated by reference number 610, less than all of the RBs of the carrier bandwidth are scheduled for sidelink communication. That is, only RBs indicated by a frequency domain resource allocation (FDRA) may be scheduled for sidelink communication. Moreover, not all of the RBs scheduled for sidelink communication are contiguous. This is because the FDRA of the example 600 shown in FIG. 6 utilizes the interlaced waveform, such that the sidelink communication is spread over a wider bandwidth than if the scheduled RBs were contiguous. Moreover, in some cases, one or more RBs of each RB set may be associated with a guard band, and thus these RBs may not be available for purposes of transmitting a sidelink communication. In such cases, the interlaces within the guard band may not form a part of the scheduled RBs, even if the interlaces correspond to one of the scheduled interlaces. For example, in FIG. 6, the guard bands include RBs associated with interlaces 0 and 4, which are scheduled interlaces as indicated by the FDRA. However, the RBs within each guard band may not be considered part of the scheduled RBs (as shown by reference number 610) because those RBs are not permitted to carry a sidelink communication.

For ease of description of the FDRA, two of the RB sets (e.g., RB set 2 and RB set 3) of the carrier bandwidth are shown in an exploded view in FIG. 6, indicated by reference number 615. As shown at reference number 615, each RB set includes a number of RBs, with each RB being associated with one of a number (e.g., M) of interlaces. In the depicted example, the carrier bandwidth is divided into five interlaces (e.g., M=5), indexed from interlace 0 to interlace 4. In such cases, every fifth RB belongs to the same interlace. The number of RBs within each RB set and associated with a particular interlace may vary according to certain configurations such as an RB set guard band configuration. More particularly, depending on the RB set guard band configuration, each RB set may include nine, ten, or eleven RBs associated with each interlace. For ease of description, only the first and last RB of each interlace in each of RB sets 2 and 3 are depicted in FIG. 6.

Moreover, although five interlaces are shown for purposes of description, in other cases more or fewer interlaces may be employed. For example, for frequency bands with a 15 kHz SCS, ten interlaces may be used, while for a frequency band with 30 kHz SCS, five interlaces may be used (such as is depicted in FIG. 6). In such cases, every tenth RB is part of the same interlace for 15 kHz SCS, and every fifth RB is part of the same interlace for 30 kHz SCS. Any other number of interlaces (e.g., any other value of M) may be employed.

In some cases, an FDRA may include an interlace indication indicating one or more scheduled interlaces for the sidelink communication and/or an RB set indication indicating one or more scheduled RB sets for the sidelink communication. For example, as indicated by reference number 620, the interlace indication of the FDRA (e.g., the X-bit indication) indicates that interlaces 0, 2, and 4 may be used for sidelink communication, which are shown using stippling in FIG. 6, and the RB set indication of the FDRA (e.g., the Y-bit indication) indicates that RB sets 2, 3, and 4 may be used for sidelink communication, which are shown using hatching in FIG. 6. The resulting resource allocation includes the intersection of these two indications (e.g., RBs of interlaces 0, 2, and 4 that are also within RB sets 2, 3, and 4).

In some cases, an FDRA may indicate which interlaces and which RB sets to use for sidelink communication relative to an interlace and/or an RB set known to both UEs (e.g., known to both Tx/Rx UE 405 and Rx/Tx UE 410). For example, the interlace indication of the FDRA may indicate interlaces to use for sidelink communication relative to an interlace associated with an RB used to transmit an SCI-1 communication. More particularly, as indicated by reference number 625, a PSCCH containing an SCI-1 communication may be transmitted in an RB associated with interlace 4. Thus, the interlace indication of the FDRA may indicate interlaces to be used for sidelink communication relative to interlace 4.

In some cases (e.g., for 30 kHz SCS cases including five interlaces), the interlace indication may be a 4-bit or 5-bit bitmap. In such cases, the bitmap may indicate scheduled interlaces using an information bit “1” and may indicate a non-scheduled interlace using an information bit “0” relative to the interlace including the SCI-1 communication. More particularly, for cases in which a 5-bit bitmap is employed, the first bit of the bitmap may correspond to the interlace including the SCI-1 communication, and thus a bitmap of 11010 indicates that the current interlace (e.g., the interlace containing the PSCCH and/or SCI-1 communication) may be used for sidelink communication (corresponding to the first information bit 1), and that the interlaces occurring one and three interlaces after the current interlace may be used for sidelink communication (corresponding to the second and third information bits 1, respectively). In the depicted example, this corresponds to interlace 4, interlace 0, and interlace 2, as shown using stippling. The information bits 0 indicate that the second and fourth interlace following the current interlace (e.g., interlaces 1 and 3 in the depicted example) are non-scheduled interlaces and thus should not be used for sidelink communication. For cases in which a 4-bit bitmap is employed, the UEs 405, 410 may always assume that the current interlace may be used for sidelink communication (e.g., the interlace including the PSCCH and/or SCI-1 communication will be assumed to form part of the resource allocation), and thus the bits will map to the four interlaces following the current interlace (e.g., the first bit in the bitmap may correspond to the interlace immediately following the interlace including the SCI-1 communication). Thus, for the depicted example, a 4-bit bitmap of 1010 would indicate that the scheduled interlaces are interlace 4 (because that is the interlace in which the PSCCH and/or SCI-1 communication was received), interlace 0 (corresponding to the first information bit 1 in the bitmap), and interlace 2 (corresponding to the second information bit 1 in the bitmap).

In some cases, the interlace indication may indicate a resource indicator value (MV) (which may also be referred to as a code point) instead of a bitmap. An MV (e.g., a code point) corresponds to a known and unique interlace pattern that may be used for sidelink communication. Put another way, the UEs may be hard-coded or configured with an index including various interlace patterns, each associated with a unique MV, and the UEs may signal to one another a particular interlace pattern from the index to be utilized by including the corresponding MV in the interlace indication of the FDRA. It may be beneficial to implement an MV or similar code point when more than five interlaces are used, such as for carrier bandwidths associated with a 15 kHz SCS utilizing ten interlaces, in order to reduce signaling overhead. More particularly, rather than implementing a ten-bit bitmap to indicate the scheduled interlaces, the RIV or similar code point may be indicated using fewer bits. Generally, a given number of bits, n, may signal 2ⁿ unique code points. Thus, using four bits, the interlace condition could indicate up to 16 (e.g., 2⁴) distinct interlace patterns to be used for sidelink communication.

As with the four-bit or five-bit bitmap described above, the RIV may indicate which interlaces may be used for sidelink communication relative to the interlace containing the PSCCH and/or SCI-1 communication. For example, in some cases a four-bit RIV may be used to indicate one of 14 different combinations of scheduled interlaces to be used for sidelink communication. These combinations of scheduled interlaces may include one to ten contiguous interlaces (e.g., RIV values corresponding to scheduling interlaces {0}, {0,1}, {0,1,2}, {0,1,2,3}, {0,1,2,3,4}, {0,1,2,3,4,5}, {0,1,2,3,4,5,6}, {0,1,2,3,4,5,6,7}, {0,1,2,3,4,5,6,7,8}, and {0,1,2,3,4,5,6,7,8,9}, where the first interlace (e.g., the interlace indexed as 0) corresponds to the interlace in which the PSCCH and/or SCI-1 communication is communicated), as well as four non-contiguous interlace combinations (e.g., {0,5}, {0,1,5,6}, {0,1,2,5,6,7}, and {0,1,2,3,5,6,7,8}). These combinations of scheduled interlaces are provided merely as examples, and in some other cases, the RIV may contain more or fewer than four bits and/or may point to more or fewer than the 14 combinations of scheduled interlaces described above. Thus, the interlace indication of the FDRA could indicate an RIV corresponding to one of the interlace patterns described above, and the receiving UE would interpret the pattern as being relative to the interlace including the RB associated with the SCI-1 communication (e.g., the “0” interlace of the above described interlace patterns is mapped to the interlace including the SCI-1 communication).

In some cases, the FDRA may indicate which RB sets to use for sidelink communication relative to an RB set associated with the SCI-1 communication. More particularly, the FDRA may include an RB set indication (e.g., a Y-bit indication) that indicates one or more scheduled RB sets for the sidelink communication. In some cases, the RB set indication may indicate a first group of zero or more contiguous RB sets associated with frequencies higher than a frequency band associated with the RB set associated with the SCI-1 communication, and the RB set indication may further indicate a second group of zero or more contiguous RB sets associated with frequencies lower than the frequency band of the RB set associated with the SCI-1 communication. In such cases, the scheduled RB sets include the first group of zero or more contiguous RB sets, the RB set associated with the SCI-1 communication, and the second group of zero or more contiguous RB sets. For example, in FIG. 6, the PSCCH containing the SCI-1 communication, indicated at reference number 625, is received within the fourth RB set (indexed as RB set 3). In this example, the RB set indication may indicate that one RB set associated with frequencies higher than the frequency band associated with the RB set associated with the SCI-1 communication (e.g., RB set 4) is scheduled for sidelink communication, and that one RB set associated with frequencies lower than the frequency band associated with the RB set associated with the SCI-1 communication is scheduled for sidelink communication (e.g., RB set 2). Thus, the scheduled RB sets would include the RB set associated with the SCI-1 communication (e.g., RB set 1) as well as the additionally indicated RB sets (e.g., RB sets 2 and 4).

In some cases, the RB set indicator may be a code point or similar indicator indicating (L, H) RB sets that are scheduled for sidelink communication in addition to the RB set associated with the SCI-1 communication, where L is a number of contiguous RB sets having frequencies lower than the RB set associated with the SCI-1 communication, and where H is a number of contiguous RB sets having frequencies higher than the RB set associated with the SCI-1 communication. For carrier bandwidths having a bandwidth of 80 MHz composed of four RB sets or subchannels, a four-bit RB set indication (e.g., a four-bit code point), which may indicate up to 16 distinct combinations of RB sets (e.g., 2 4=16), may be used to indicate one of the following ten (L, H) combinations of scheduled RB sets: (0,0) (e.g., only the RB set associated with the SCI-1 communication is scheduled for sidelink communication), (0,1), (1,0), (0,2), (1,1), (2,0), (0,3), (1,2), (2,1), or (3,0). Similarly, for bandwidth parts having a bandwidth of 100 MHz composed of five RB sets or subchannels, a four-bit RB set indication (e.g., a four-bit code point), which may indicate up to 16 distinct combinations of RB sets, may be used to indicate 15 combinations of scheduled RB sets, which include, in addition to the above described ten combinations, the following (L, H) combinations of RB sets: (0,4), (1,3), (2,2), (3,1), or (4,0). In the example depicted in FIG. 6, the RB set indication may indicate that the scheduled RB sets are (1,1) (e.g., one RB set higher than the RB set associated with the SCI-1 communication (e.g., RB set 4) and one RB set lower than the RB set associated with the SCI-1 communication (e.g., RB set 2), in addition to the RB set associated with SCI-1 communication (e.g., RB set 3)).

In some cases, the RB set indication may be limited to scheduling only RB sets having frequency bands higher than the frequency band of the RB set associated with the SCI-1 communication. Put another way, the SCI-1 communication may be limited to being transmitted in the lowest frequency RB set in the allocation. In such cases, the RB set indication only needs to indicate a number of contiguous RB sets having frequencies above the frequency band of the RB set associated with the SCI-1 communication. For 80 MHz channels composed of four 20 MHz subchannels, the RB set indication may thus indicate one of four combinations of RB sets scheduled for sidelink communication: 0, 1, 2, or 3 RB sets associated with frequencies above the frequency band of the RB set associated with the SCI-1 communication. For 100 MHz channels composed of five 20 MHz subchannels, the RB set indication may thus indicate one of five combinations of RB sets scheduled for sidelink communication: 0, 1, 2, 3, or 4 RB sets associated with frequencies above the frequency band of the RB set associated with the SCI-1 communication. In such cases, the RB set indication may thus be at least two bits for 80 MHz implementations (which can point to up to 2 2=4 combinations of RB sets), or three bits for 100 MHz implementations (which can point to up to 2 3=8 combinations of RB sets).

Although the scheduled interlaces and the scheduled RB sets are described in the above examples as being indicated relative to an RB and/or an RB set used to send an initial PSCCH communication (e.g., the scheduled interlaces are indicated relative to an RB including the SCI-1 communication and the scheduled RB sets are indicated relative to an RB set including the SCI-1 communication), in some other examples, the scheduled interlaces and/or the scheduled RB sets may be indicated relative to a common reference point known to both UEs communicating on the sidelink, sometimes referred to as a point A. For example, each UE may be hard-coded or configured with one or more common reference points (e.g., one or more point As), and the bitmaps and/or code points described above may indicate the scheduled interlaces relative to an interlace including the common reference point and/or may indicate the scheduled RB sets relative to an RB set including the common reference point. In some examples, the common reference point (point A) may be a channel-specific common reference point (e.g., a first common reference point is defined for a first channel or a first group of channels, a second common reference point is defined for a second channel or a second group of channels, and so forth). In some other examples, the common reference point may be configured to be within a point A grid, with the point A grid (sometimes referred to as a common reference point grid) being defined by the product of the RB size of the frequency band being utilized for sidelink communication and the number of interlaces available for sidelink communication. For example, sidelink communications occurring in a frequency band having a 15 kHz SCS with ten available interlaces for sidelink communication may have a point A grid of ten RBs, which equals a bandwidth of 1.8 MHz, with the common reference point (e.g., point A) being placed on the 1.8 MHz grid. Additionally, or alternatively, sidelink communications occurring in a frequency band having a 30 kHz SCS with five interlaces available for sidelink communication may have a point A grid of five RBs, which equals a bandwidth of 1.8 MHz, with the common reference point (e.g., point A) being placed on the 1.8 MHz grid.

In some cases, the sidelink UEs may not have the same reference point, and the absolute interlace index definitions for the sidelink UEs may be different. In some cases, the FDRA for the sidelink communication may be based at least in part on a relative allocation starting from the current subchannel and may indicate how many subchannels are allocated. In some cases, a relative X-bit and a relative Y-bit (X,Y) may be indicated for sidelink PSSCH. The relative X-bit (e.g., bitmap or RIV) may be based at least in part on the scheduling SCI-1 interlace. For example, the relative X-bit may be defined with respect to the scheduling SCI-1 interlace. In some cases, the relative X-bit may indicate which interlace(s) are allocated (e.g., with wrap-around). The relative Y-bit may be based at least in part on the SCI-1 reception resource block set. For example, the relative Y-bit bay be defined with respect to the SCI-1 reception resource block set. In some cases, the relative Y-bit may indicate the number of occupied resource block sets starting from the SCI-1 reception resource block set.

In some cases, a UE may determine the number of resource elements (REs) allocated for the PSSCH within a physical resource block (PRB). For example, the UE may determine the number of REs allocated for the PSSCH within the PRB (N′_{RE}) based at least in part on the following:

N′_{RE}=N_{sc}^{RB}(N_{symb}^{sh}−N_{symb}^{PSFCH})−Nₒₕ^{PRB}−N_{RE}^{DMRS}, where
N_{sc}^{RB}=12 is the number of subcarriers in the PRB;
N_{symb}^{sh}=sl-LengthSymbols-2, where sl-LengthSymbols is the number of sidelink symbols within the slot provided by a higher layer;
N_{symb}^{PSFCH}=3 if a PSFCH overhead indication field of the SCI format 1-A indicates “1”, and N_{symb}^{PSFCH}=0 otherwise, if the higher layer parameter sl-PSFCH-Period is 2 or 4 (if the higher layer parameter sl-PSFCH-Period is 0, N_{symb}^{PSFCH}=0; if the higher layer parameter sl-PSFCH-Period is 1, N_{symb}^{PSFCH}=3);
Nₒₕ^{PRB} is the overhead given by a higher layer parameter si-X-Overhead; and
N_{RE}^{DMRS} is given by Table 8.1.3.2-1 according to a higher layer parameter sl-PSSCH-DMRS-TimePattern.

In some cases, the UE may determine the total number of REs allocated for the PSSCH (N_{RE}) based at least in part on the following:

N_{RE}=N′_{RE}*n_{PRB}−N_{RE}^{SCI,1}−N_{RE}^{SCI,2}, where
n_{PRB} is the total number of allocated PRBs for the PSSCH;
N_{RE}^{SCI,1} is the total number of REs occupied by the PSCCH and the PSCCH DMRS; and
N_{RE}^{SCI,2} is the total number of coded modulation symbols generated for SCI-2 transmission (prior to a duplication for the second layer, if present) according to clause 8.4.4 of Technical Specification (TS) 38.212 of the 3GPP Specifications, with the assumption of y=0.

In some cases, different subchannels (interlaces) may have different numbers of PRBs. For example, different interlaces in the same resource block set may have different numbers of PRBs (such as 9 RBs, 10 RBs, or 11 RBs, among other examples). The same interlace in different resource block sets may have different numbers of PRBs (e.g., due to different inter-cell guard band configurations). In some cases, SCI-1 may be used to reserve up to two future sidelink resources for one or more retransmissions of a communication. The frequency RIV (FRIV) field design may assume the same number of subchannels for all reserved SL resources. For the one or more retransmissions of the communication, the transport block size (TB S) may need to be the same as the initial transmission to avoid re-encoding. In some cases, sidelink communications may be assumed to use subchannels having equal sizes. This may result in the same TBS size for both the initial transmission of the sidelink communication and the one or more retransmissions of the sidelink communication. However, FDRA in SCI-1 may enable the sidelink UEs to reserve subchannels across different resource block sets. This may result in the future reserved resources (e.g., subchannels) for the sidelink retransmissions not having the same number of PRBs as the subchannels for the initial transmission. As described herein, this may cause one or more errors during the one or more retransmissions of the sidelink communication, such as at least a portion of the sidelink communication not being properly retransmitted.

Techniques and apparatuses are described herein for transport block size calculation for sidelink communications. In some aspects, a UE (e.g., a transmitter UE) may obtain a nominal resource block value associated with one or more allocated subchannels for a sidelink communications, and may identify a number of PSSCH resource elements to be used for a transport block size calculation based at least in part on the nominal resource block value. The UE may transmit the sidelink communication, and may reserve one or more resources for one or more retransmissions of the sidelink communication, based at least in part on the number of PSSCH resource elements. In some aspects, the nominal resource block value may be defined per subchannel of a plurality of subchannels. In some other aspects, each nominal resource block value of a plurality of nominal resource block values may correspond to a different subchannel allocation size within a resource block set. In some aspects, obtaining the nominal resource block value may include selecting the nominal resource block value associated with a subchannel, from a plurality of nominal resource block values associated with a respective plurality of allocated subchannels, having the smallest number of interlace resource blocks.

As described above, sidelink communications may be assumed to use subchannels having equal sizes. This may result in the same transport block size for the initial transmission of the sidelink communication and the one or more retransmissions of the sidelink communication. However, FDRA in SCI-1 may enable the sidelink UEs to reserve subchannels across different resource block sets. This may result in the future reserved resources for the one or more retransmissions of the sidelink communication not having the same number of PRBs as the resources for the initial transmission, which may cause one or more errors during the retransmission of the sidelink communication, such as at least a portion of the sidelink communication not being properly retransmitted. Using the techniques and apparatuses described herein, the UE may obtain a nominal resource block value, and may identify a number of PSSCH resource elements to be used for a transport block size calculation based at least in part on the nominal resource block value. The UE may transmit the sidelink communication, and may reserve one or more resources for the one or more retransmissions of the sidelink communication, based at least in part on the identified PSSCH resource elements. This may result in the future reserved resources for the one or more retransmissions having the same number of PRBs as the resources for the initial transmission of the sidelink communication, which may reduce the likelihood of errors during the retransmission of the communication.

As indicated above, FIG. 6 is provided as an example. Other examples may differ from what is described with respect to FIG. 6.

FIG. 7 is a diagram illustrating an example 700 of transport block size calculation for sidelink communications, in accordance with the present disclosure. A transmitter UE 705 may communicate with a receiver UE 710 (or multiple receiver UEs 710). The transmitter UE 705 and the receiver UE 710 may include some or all of the features of the UE 120, UE 305, UE 405, and/or UE 410 described herein.

As shown by reference number 715, the transmitter UE 705 may obtain a nominal resource block value associated with one or more allocated subchannels for a sidelink communication. In some aspects, a number of allocated PSSCH resource elements to be used for a TBS calculation may be based at least in part on the actual number of resource blocks of the scheduled subchannel(s). In some aspects:

N_{RE}=N′_{RE}*n_{PRB}−N_{RE}^{SCI,1}−N_{RE}^{SCI,2}, where
N′_{NE} is the number of REs allocated for the PSSCH within the PRB;
n_{PRB} is the total number of allocated PRBs for the PSSCH;
N_{RE}^{SCI,1} is the total number of REs occupied by the PSCCH and the PSCCH DMRS; and
N_{RE}^{SCI,2} is the total number of coded modulation symbols generated for the SCI-2 transmission.

In some aspects, to ensure the same TBS for an initial transmission of the sidelink communication and the one or more retransmissions of the sidelink communication, the same (or similar) N_{RE} values may be desirable for the initial transmission and the one or more retransmissions. In some aspects, to ensure the same TBS for the initial transmission and the one or more retransmissions of the sidelink communication, the same (or a similar) number of allocated PSSCH resource elements may be desirable for the initial transmission and the one or more retransmissions, as long as the same number of subchannels is reserved for the retransmission. In some aspects, the future reserved resources for the one or more retransmissions may be in different interlaces and/or different resource block sets.

In some aspects, the number of allocated PSSCH resource elements to be used for the TBS calculation may be based at least in part on a nominal resource block value for the allocated subchannel(s). In some aspects, the nominal resource block value may be defined per subchannel. The nominal resource block that is defined per subchannel may be referred to as n_{PRB,subch,nom}. One sidelink subchannel may correspond to one or more (K) interlaces in a resource block set. In some aspects, for one interlace subchannel, the nominal resource block value per subchannel may be defined as 9 RBs, 10 RBs, or 11 RBs, among other examples. In some aspects, the number of allocated PRBs for the PSSCH (n_{PRB}) may be based at least in part on the number of allocated subchannels and the nominal resource block value defined per subchannel. In some aspects, np RB may be a product of n_{PRB,subch,nom} and n_{subch}, where n subch is the number of allocated subchannels. Using the two part FDRA (X,Y) described herein, the same number of subchannels may be scheduled in different resource block sets. In some aspects, the allocated subchannels within the resource block set may be contiguous in frequency.

In some aspects, different nominal resource block values may be identified for different subchannel allocation sizes within a resource block set. This may minimize the difference between the nominal number of resource blocks and the actual number of resource blocks in the allocated subchannel. In some aspects, for n_{subch} contiguous subchannel allocations within the resource block set, the nominal resource block value may be Y(n_{subch}), which may be a function of n_{subch}. In this case, different numbers of subchannel allocations within the resource block may map to different nominal RB values. In some aspects, Y(n subch) may depend on all of the resource block set configurations, as described in more detail herein. In some aspects, the number of allocated PSSCH resource elements to be used for the TBS calculation may be based at least in part on the actual number of resource blocks of the scheduled subchannel(s). In some aspects:

N_{RE}=N′_{RE}·Y(n_{subch})−N_{RE}^{SCI,1}−N_{RE}^{SCI,2}, where
N′_{RE} is the number of REs allocated for the PSSCH within the PRB;
Y(n_{subch}) is the nominal resource block value;
N_{RE}^{SCI,1} is the total number of resource elements occupied by the PSCCH and the PSCCH DMRS; and
N_{RE}^{SCI,2} is the total number of coded modulation symbols generated for the SCI-2 transmission.

In some aspects, the transmitter UE 705 may select the nominal resource block value for the subchannel. Selecting a nominal resource block value that is too small may reduce the spectral efficiency, particularly in high throughput scenarios. Alternatively, selecting a nominal resource block value that is too large may reduce the transmission reliability, since the allocated subchannel(s) (e.g., interlaces) may have a smaller number of resource blocks than the nominal value. An example relationship between interlace index values and a number of resource blocks within a corresponding resource block set is shown in Table 1.

TABLE 1

| Interlace Index | 0 | 1 | 2 | 3 | 4 |
|---|---|---|---|---|---|
| Number of RBs | 9 | 9 | 10 | 9 | 9 |
| in the RB set | | | | | |

In some aspects, the transmitter UE 705 may select the nominal resource block value for the subchannel(s) based at least in part on the subchannel(s) that has the smallest number of interlace resource blocks (IRBs). In some aspects, based at least in part on the resource block set configuration, different subchannels (interlaces) in the same (or different) resource block sets may have different numbers of interlace resource blocks. In some aspects, for a plurality of subchannels having different numbers of interlace resource blocks (e.g., at least two subchannels having different number of interlace resource blocks), the transmitter UE 705 may select the nominal resource block value based at least in part on the subchannel that has the smallest number of interlace resource blocks.

In some aspects, such as when the nominal resource block value is defined per subchannel, the transmitter UE 705 may select the nominal resource block value based at least in part on the subchannel having the smallest size across all resource block sets. In this case, the transport block size may be based at least in part on (e.g., may be limited by) the smallest subchannel. In an aspect where n_{subch}=3 contiguous subchannels, the nominal number of resource blocks for the three subchannels (np RB) may be 27 resource blocks.

In some other aspects, such as when different nominal resource block values are identified for different subchannel allocation sizes within the resource block set, for each subchannel allocation size (n_{subch}), the transmitter UE 705 may select the minimum number of available interlace resource blocks for all of the potential resource block allocations across all of the resource block sets. In an aspect where n_{subch}=3 contiguous subchannels, the nominal number of resource blocks for the three subchannels (np RB) may be 28 resource blocks.

As shown by reference number 720, the transmitter UE 705 may identify a number of PSSCH resource elements to be used for a transport block size calculation based at least in part on the nominal resource block value. As described herein, to ensure the same transport block size for the initial transmission of the sidelink communication and the one or more retransmissions of the sidelink communication, the same (or similar) N_{RE} values may be desirable for the initial transmission and the one or more retransmissions. The transmitter UE 705 may identify (e.g., determine) the number of PSSCH resource elements to be used for the transport block size calculation based at least in part on the nominal resource block value.

As shown by reference number 725, the transmitter UE 705 may transmit the sidelink communication, and may reserve one or more resources for one or more respective retransmissions of the sidelink communication, based at least in part on the number of PSSCH resource elements.

As described above, sidelink communications may be assumed to use subchannels having equal sizes. This may result in the same transport block size for the initial transmission of the sidelink communication and the one or more retransmissions of the sidelink communication. However, FDRA in SCI-1 may enable the sidelink UEs to reserve subchannels across different resource block sets. This may result in the future reserved resources for the one or more retransmissions of the sidelink communication not having the same number of PRBs as the resources for the initial transmission, which may cause one or more errors during the retransmission of the sidelink communication, such as at least a portion of the sidelink communication not being properly retransmitted. Using the techniques and apparatuses described herein, the transmitter UE 705 may obtain a nominal resource block value, and may identify a number of PSSCH resource elements to be used for a transport block size calculation based at least in part on the nominal resource block value. The transmitter UE 705 may transmit the sidelink communication, and may reserve one or more resources for the one or more retransmissions of the sidelink communication, based at least in part on the identified PSSCH resource elements. This may result in the future reserved resources for the one or more retransmissions having the same number of PRBs as the resources for the initial transmission of the sidelink communication, which may reduce the likelihood of errors during the retransmission of the communication.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with transport block size for sidelink communications.

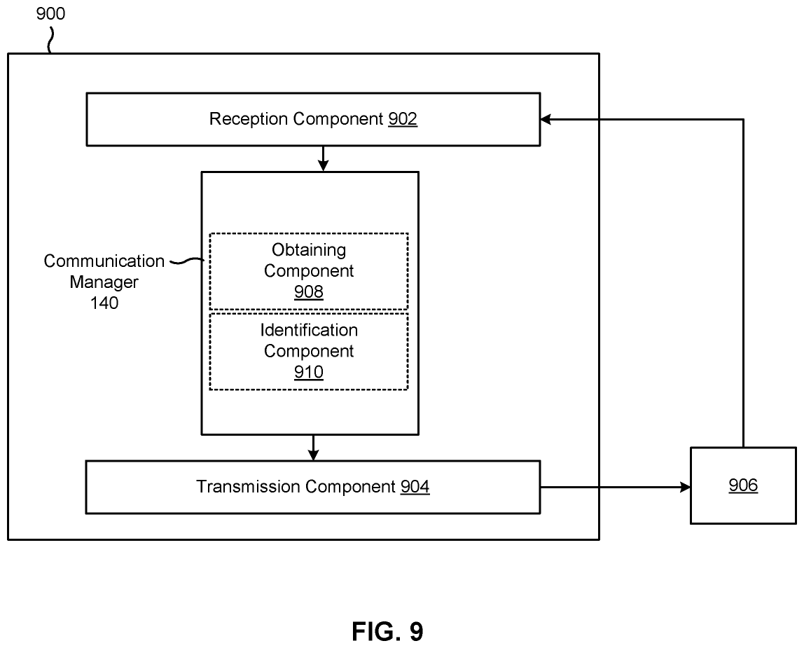

As shown in FIG. 8, in some aspects, process 800 may include obtaining a nominal resource block value associated with one or more allocated subchannels for a sidelink communication (block 810). For example, the UE (e.g., using communication manager 140, receiving component 902, and/or obtaining component 908, depicted in FIG. 9) may obtain a nominal resource block value associated with one or more allocated subchannels for a sidelink communication, as described above.

As further shown in FIG. 8, in some aspects, process 800 may include identifying a number of PSSCH resource elements to be used for a transport block size calculation based at least in part on the nominal resource block value (block 820). For example, the UE (e.g., using communication manager 140 and/or identification component 910, depicted in FIG. 9) may identify a number of PSSCH resource elements to be used for a transport block size calculation based at least in part on the nominal resource block value, as described above.

As further shown in FIG. 8, in some aspects, process 800 may include transmitting the sidelink communication, and reserving one or more resources for one or more respective retransmissions of the sidelink communication, based at least in part on the number of PSSCH resource elements (block 830). For example, the UE (e.g., using communication manager 140 and/or transmission component 904, depicted in FIG. 9) may transmit the sidelink communication, and reserve one or more resources for one or more respective retransmissions of the sidelink communication, based at least in part on the number of PSSCH resource elements, as described above.

Process 800 may include additional aspects, such as any single aspect or any combination of aspects described below and/or in connection with one or more other processes described elsewhere herein.

In a first aspect, the one or more allocated subchannels comprise a plurality of subchannels, and the nominal resource block value is defined per subchannel of the plurality of subchannels.

In a second aspect, alone or in combination with the first aspect, a select subchannel of the plurality of subchannels corresponds to one or more interlaces in a resource block set.

In a third aspect, alone or in combination with one or more of the first and second aspects, a total number of allocated physical resource blocks for the PSSCH is based at least in part on the number of subchannels associated with the plurality of subchannels and the nominal resource block value.

In a fourth aspect, alone or in combination with one or more of the first through third aspects, the total number of allocated physical resource blocks for the PSSCH is the number of subchannels multiplied by the nominal resource block value.

In a fifth aspect, alone or in combination with one or more of the first through fourth aspects, the plurality of subchannels comprises a plurality of subchannels within a resource block set that are contiguous in frequency.

In a sixth aspect, alone or in combination with one or more of the first through fifth aspects, obtaining the nominal resource block value comprises obtaining a plurality of nominal resource block values, wherein each nominal resource block value of the plurality of nominal resource block values corresponds to a different subchannel allocation size within a resource block set.

In a seventh aspect, alone or in combination with one or more of the first through sixth aspects, each nominal resource block value of the plurality of nominal resource block values corresponds to a respective subchannel allocation size of a plurality of subchannel allocation sizes within the resource block set.

In an eighth aspect, alone or in combination with one or more of the first through seventh aspects, identifying the number of PSSCH resource elements to be used for the transport block size calculation comprises identifying the number of PSSCH resource elements based at least in part on an actual number of resource blocks to be used for a scheduled subchannel of the one or more allocated subchannels.

In a ninth aspect, alone or in combination with one or more of the first through eighth aspects, obtaining the nominal resource block value comprises selecting the nominal resource block value associated with a subchannel, from a plurality of nominal resource block values associated with a respective plurality of allocated subchannels, having a smallest number of interlace resource blocks.

In a tenth aspect, alone or in combination with one or more of the first through ninth aspects, at least two subchannels of the plurality of allocated subchannels have a different number of interlace resource blocks.

In an eleventh aspect, alone or in combination with one or more of the first through tenth aspects, selecting the nominal resource block value associated with the subchannel having the smallest number of interlace resource blocks comprises selecting the nominal resource block value associated with the subchannel having the smallest number of interlace resource blocks across all possible resource block sets.

In a twelfth aspect, alone or in combination with one or more of the first through eleventh aspects, the transport block size is based at least in part on a smallest subchannel of the plurality of allocated subchannels.

In a thirteenth aspect, alone or in combination with one or more of the first through twelfth aspects, selecting the nominal resource block value associated with the subchannel having the smallest number of interlace resource blocks comprises selecting the nominal resource block value associated with the subchannel having the smallest number of interlace resource blocks for each subchannel size of a plurality of subchannel sizes.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of an obtaining component 908 or an identification component 910, among other examples.

In some aspects, the apparatus 900 may be configured to perform one or more operations described herein in connection with FIG. 7. Additionally, or alternatively, the apparatus 900 may be configured to perform one or more processes described herein, such as process 800 of FIG. 8. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The obtaining component 908 may obtain a nominal resource block value associated with one or more allocated subchannels for a sidelink communication. The identification component 910 may identify a number of PSSCH resource elements to be used for a transport block size calculation based at least in part on the nominal resource block value. The transmission component 904 may transmit the sidelink communication, and reserve one or more resources for one or more respective retransmissions of the sidelink communication, based at least in part on the number of PSSCH resource elements.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: obtaining a nominal resource block value associated with one or more allocated subchannels for a sidelink communication; identifying a number of physical sidelink shared channel (PSSCH) resource elements to be used for a transport block size calculation based at least in part on the nominal resource block value; and transmitting the sidelink communication, and reserving one or more resources for one or more respective retransmissions of the sidelink communication, based at least in part on the number of PSSCH resource elements.

Aspect 2: The method of Aspect 1, wherein the one or more allocated subchannels comprises a plurality of subchannels, and wherein the nominal resource block value is defined per subchannel of the plurality of subchannels.

Aspect 3: The method of Aspect 2, wherein a select subchannel of the plurality of subchannels corresponds to one or more interlaces in a resource block set.

Aspect 4: The method of Aspect 2, wherein a total number of allocated physical resource blocks for the PSSCH is based at least in part on the number of subchannels associated with the plurality of subchannels and the nominal resource block value.

Aspect 5: The method of Aspect 4, wherein the total number of allocated physical resource blocks for the PSSCH is the number of subchannels multiplied by the nominal resource block value.

Aspect 6: The method of Aspect 2, wherein the plurality of subchannels comprises a plurality of subchannels within a resource block set that are contiguous in frequency.

Aspect 7: The method of any of Aspects 1-6, wherein obtaining the nominal resource block value comprises obtaining a plurality of nominal resource block values, wherein each nominal resource block value of the plurality of nominal resource block values corresponds to a different subchannel allocation size within a resource block set.

Aspect 8: The method of Aspect 7, wherein each nominal resource block value of the plurality of nominal resource block values corresponds to a respective subchannel allocation size of a plurality of subchannel allocation sizes within the resource block set.

Aspect 9: The method of Aspect 7, wherein identifying the number of PSSCH resource elements to be used for the transport block size calculation comprises identifying the number of PSSCH resource elements based at least in part on an actual number of resource blocks to be used for a scheduled subchannel of the one or more allocated subchannels.

Aspect 10: The method of any of Aspects 1-9, wherein obtaining the nominal resource block value comprises selecting the nominal resource block value associated with a subchannel, from a plurality of nominal resource block values associated with a respective plurality of allocated subchannels, having a smallest number of interlace resource blocks.

Aspect 11: The method of Aspect 10, wherein at least two subchannels of the plurality of allocated subchannels have a different number of interlace resource blocks.

Aspect 12: The method of Aspect 10, wherein selecting the nominal resource block value associated with the subchannel having the smallest number of interlace resource blocks comprises selecting the nominal resource block value associated with the subchannel having the smallest number of interlace resource blocks across all possible resource block sets.

Aspect 13: The method of Aspect 12, wherein the transport block size is based at least in part on a smallest subchannel of the plurality of allocated subchannels.

Aspect 14: The method of Aspect 10, wherein selecting the nominal resource block value associated with the subchannel having the smallest number of interlace resource blocks comprises selecting the nominal resource block value associated with the subchannel having the smallest number of interlace resource blocks for each subchannel size of a plurality of subchannel sizes.

Aspect 15: An apparatus for wireless communication at a device, comprising a processor; memory coupled with the processor; and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
obtain a nominal resource block value associated with one or more allocated subchannels for a sidelink communication;
identify a number of physical sidelink shared channel (PSSCH) resource elements to be used for a transport block size calculation based at least in part on the nominal resource block value; and
transmit the sidelink communication, and reserve one or more resources for one or more respective retransmissions of the sidelink communication, based at least in part on the number of PSSCH resource elements.

2. The apparatus of claim 1, wherein the one or more allocated subchannels comprises a plurality of subchannels, and wherein the nominal resource block value is defined per subchannel of the plurality of subchannels.

3. The apparatus of claim 2, wherein a select subchannel of the plurality of subchannels corresponds to one or more interlaces in a resource block set.

4. The apparatus of claim 2, wherein a total number of allocated physical resource blocks for the PSSCH is based at least in part on the number of subchannels associated with the plurality of subchannels and the nominal resource block value.

5. The apparatus of claim 4, wherein the total number of allocated physical resource blocks for the PSSCH is the number of subchannels multiplied by the nominal resource block value.

6. The apparatus of claim 2, wherein the plurality of subchannels comprises a plurality of subchannels within a resource block set that are contiguous in frequency.

7. The apparatus of claim 1, wherein the one or more processors, to obtain the nominal resource block value, are configured to obtain a plurality of nominal resource block values, wherein each nominal resource block value of the plurality of nominal resource block values corresponds to a different subchannel allocation size within a resource block set.

8. The apparatus of claim 7, wherein each nominal resource block value of the plurality of nominal resource block values corresponds to a respective subchannel allocation size of a plurality of subchannel allocation sizes within the resource block set.

9. The apparatus of claim 7, wherein the one or more processors, to identify the number of PSSCH resource elements to be used for the transport block size calculation, are configured to identify the number of PSSCH resource elements based at least in part on an actual number of resource blocks to be used for a scheduled subchannel of the one or more allocated subchannels.

10. The apparatus of claim 1, wherein the one or more processors, to obtain the nominal resource block value, are configured to select the nominal resource block value associated with a subchannel, from a plurality of nominal resource block values associated with a respective plurality of allocated subchannels, having a smallest number of interlace resource blocks.

11. The apparatus of claim 10, wherein at least two subchannels of the plurality of allocated subchannels have a different number of interlace resource blocks.

12. The apparatus of claim 10, wherein the one or more processors, to select the nominal resource block value associated with the subchannel having the smallest number of interlace resource blocks, are configured to select the nominal resource block value associated with the subchannel having the smallest number of interlace resource blocks across all possible resource block sets.

13. The apparatus of claim 12, wherein the transport block size is based at least in part on a smallest subchannel of the plurality of allocated subchannels.

14. The apparatus of claim 10, wherein the one or more processors, to select the nominal resource block value associated with the subchannel having the smallest number of interlace resource blocks, are configured to select the nominal resource block value associated with the subchannel having the smallest number of interlace resource blocks for each subchannel size of a plurality of subchannel sizes.

15. A method of wireless communication performed by a user equipment (UE), comprising:
obtaining a nominal resource block value associated with one or more allocated subchannels for a sidelink communication;
identifying a number of physical sidelink shared channel (PSSCH) resource elements to be used for a transport block size calculation based at least in part on the nominal resource block value; and
transmitting the sidelink communication, and reserving one or more resources for one or more respective retransmissions of the sidelink communication, based at least in part on the number of PSSCH resource elements.

16. The method of claim 15, wherein the one or more allocated subchannels comprises a plurality of subchannels, and wherein the nominal resource block value is defined per subchannel of the plurality of subchannels.

17. The method of claim 16, wherein a total number of allocated physical resource blocks for the PSSCH is based at least in part on the number of subchannels associated with the plurality of subchannels and the nominal resource block value.

18. The method of claim 15, wherein obtaining the nominal resource block value comprises obtaining a plurality of nominal resource block values, wherein each nominal resource block value of the plurality of nominal resource block values corresponds to a different subchannel allocation size within a resource block set.

19. The method of claim 18, wherein each nominal resource block value of the plurality of nominal resource block values corresponds to a respective subchannel allocation size of a plurality of subchannel allocation sizes within the resource block set.

20. The method of claim 18, wherein identifying the number of PSSCH resource elements to be used for the transport block size calculation comprises identifying the number of PSSCH resource elements based at least in part on an actual number of resource blocks to be used for a scheduled subchannel of the one or more allocated subchannels.

21. The method of claim 15, wherein obtaining the nominal resource block value comprises selecting the nominal resource block value associated with a subchannel, from a plurality of nominal resource block values associated with a respective plurality of allocated subchannels, having a smallest number of interlace resource blocks.

22. The method of claim 21, wherein selecting the nominal resource block value associated with the subchannel having the smallest number of interlace resource blocks comprises selecting the nominal resource block value associated with the subchannel having the smallest number of interlace resource blocks across all possible resource block sets, or selecting the nominal resource block value associated with the subchannel having the smallest number of interlace resource blocks for each subchannel size of a plurality of subchannel sizes.

23. A non-transitory computer-readable medium storing a set of instructions for wireless communication, the set of instructions comprising:
one or more instructions that, when executed by one or more processors of a user equipment (UE), cause the UE to:
obtain a nominal resource block value associated with one or more allocated subchannels for a sidelink communication;
identify a number of physical sidelink shared channel (PSSCH) resource elements to be used for a transport block size calculation based at least in part on the nominal resource block value; and
transmit the sidelink communication, and reserve one or more resources for one or more respective retransmissions of the sidelink communication, based at least in part on the number of PSSCH resource elements.

24. The non-transitory computer-readable medium of claim 23, wherein the one or more allocated subchannels comprises a plurality of subchannels, and wherein the nominal resource block value is defined per subchannel of the plurality of subchannels.

25. The non-transitory computer-readable medium of claim 23, wherein the one or more instructions, that cause the UE to obtain the nominal resource block value, cause the UE to obtain a plurality of nominal resource block values, wherein each nominal resource block value of the plurality of nominal resource block values corresponds to a different subchannel allocation size within a resource block set.

26. The non-transitory computer-readable medium of claim 23, wherein the one or more instructions, that cause the UE to obtain the nominal resource block value, cause the UE to select the nominal resource block value associated with a subchannel, from a plurality of nominal resource block values associated with a respective plurality of allocated subchannels, having a smallest number of interlace resource blocks.

27. An apparatus for wireless communication, comprising:
means for obtaining a nominal resource block value associated with one or more allocated subchannels for a sidelink communication;
means for identifying a number of physical sidelink shared channel (PSSCH) resource elements to be used for a transport block size calculation based at least in part on the nominal resource block value; and
means for transmitting the sidelink communication, and reserving one or more resources for one or more respective retransmissions of the sidelink communication, based at least in part on the number of PSSCH resource elements.

28. The apparatus of claim 27, wherein the one or more allocated subchannels comprises a plurality of subchannels, and wherein the nominal resource block value is defined per subchannel of the plurality of subchannels.

29. The apparatus of claim 27, wherein obtaining the nominal resource block value comprises obtaining a plurality of nominal resource block values, wherein each nominal resource block value of the plurality of nominal resource block values corresponds to a different subchannel allocation size within a resource block set.

30. The apparatus of claim 27, wherein the means for obtaining the nominal resource block value comprises means for selecting the nominal resource block value associated with a subchannel, from a plurality of nominal resource block values associated with a respective plurality of allocated subchannels, having a smallest number of interlace resource blocks.
